(19) United States
(12) Patent Application Publication
(10) Pub. No.: US 2026/0103056 A1
(43) Pub. Date: Apr. 16, 2026

(54) RETRACTABLE WINDSHIELD

(71) Applicant: Textron Inc., Providence, RI (US)

(72) Inventors: Ricky Veldee Kemp, Augusta, GA (US); Christopher Kenneth Furman, Evans, GA (US); Trevor Douglas Roebuck, Evans, GA (US)

(73) Assignee: Textron Inc., Providence, RI (US)

(21) Appl. No.: 18/911,840

(22) Filed: Oct. 10, 2024

(51) Int. Cl. B60J 1/04; B62D 25/06

(52) U.S. Cl. CPC B60J 1/04; B62D 25/06

(57) ABSTRACT

A canopy assembly includes a first support including a first canopy support portion and a first connection support portion, a second support including a second canopy support portion and a second connection support portion, and a canopy supported by the first canopy support portion and the second canopy support portion. The canopy assembly includes a windshield assembly including a first track and a second track aligned with and coupled to the first canopy support portion and the second canopy support portion, a windshield, a windshield support coupled to the windshield and slidably coupled to the first track and the second track, a first link and a second link pivotably coupled to (a) the windshield and (b) the first connection support portion and the second connection support portion, respectively.

### BACKGROUND

Recreational vehicles are used to transport personnel and equipment between different areas. By way of example, a recreational vehicle may transport golfers and equipment (e.g., golf bags, golf clubs, etc.) around a golf course (e.g., along a cart path, between different holes, etc.). It may be desirable to improve the comfort of operators and/or passengers of the recreational vehicle by retracting the windshield to allow a breeze to flow through the recreational vehicle.

### SUMMARY

One embodiment relates to a canopy assembly for a vehicle. The canopy assembly includes a first support including a first canopy support portion and a first connection support portion, a second support including a second canopy support portion and a second connection support portion, and a canopy supported by the first canopy support portion and the second canopy support portion. Each of the first canopy support portion and the second canopy support portion is configured to be oriented substantially parallel to a frame of the vehicle. Each of the first connection support portion and the second connection support potion extends downward from the first canopy support portion and the second canopy support portion, respectively. The canopy assembly also includes a windshield assembly. The windshield assembly includes a first track aligned with and coupled to the first canopy support portion, a second track aligned with and coupled to the second canopy support portion, a windshield, a windshield support coupled to the windshield and slidably coupled to the first track and the second track, a first link pivotably coupled to the windshield and the first connection support portion, and a second link pivotably coupled to the windshield and the second connection support portion.

Another embodiment relates to a windshield assembly for a vehicle. The windshield assembly includes a first track, a second track, a windshield, a windshield support coupled to the windshield and slidably coupled to the first track and the second track, a first link pivotably coupled to the windshield, and a second link pivotably coupled to the windshield.

Still another embodiment relates to a canopy assembly for a vehicle. The canopy assembly includes a first canopy support, a second canopy support, a canopy supported by the first canopy support and the second canopy support, and a windshield assembly. The windshield assembly includes a first track coupled to the first support, a second track coupled to the second support, a windshield, a first windshield support coupled to an upper portion of the windshield where the first windshield support slidably coupled to the first track and the second track, a first handle coupled to the first windshield support, a second windshield support coupled to a lower portion of the windshield, a second handle coupled to the second windshield support, a first link pivotably coupled to the second windshield support and the first canopy support, a second link pivotably coupled to the second windshield support and the second canopy support, and a locking mechanism including a pin that engages with one or more apertures defined by at least one of the first canopy support or the first track. The locking mechanism is configured to secure the windshield in at least one of a closed position or an open position.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a perspective view of a canopy assembly including a windshield assembly for the vehicle of FIG. 1 in a closed position, according to an exemplary embodiment.

FIG. 4 is a perspective view of the canopy assembly of FIG. 3 with the windshield assembly in an open position, according to an exemplary embodiment.

FIG. 5 is a side perspective view of the canopy assembly of FIG. 3 with the windshield assembly in the closed positioned, according to an exemplary embodiment

FIG. 6 is a front perspective view of the windshield assembly of FIG. 3 in a closed position, according to an exemplary embodiment.

FIG. 7 is a rear perspective view of the windshield assembly of FIG. 6 in the closed position, according to an exemplary embodiment.

FIG. 8 is a side perspective view of the windshield assembly of FIG. 6 in the closed position, according to an exemplary embodiment.

FIG. 9 is a perspective view of a locking mechanism of the windshield assembly of FIG. 6, according to an exemplary embodiment.

FIG. 10 is a side perspective view of the canopy assembly of FIG. 3 with the windshield assembly in a first partially open position, according to an exemplary embodiment.

FIG. 11 is a side perspective view of the canopy assembly of FIG. 3 with the windshield assembly in a second partially open position, according to an exemplary embodiment.

FIG. 12 is a side perspective view of the canopy assembly of FIG. 3 with the windshield assembly in a fully open position, according to an exemplary embodiment.

FIG. 13 is a side view of the canopy assembly of FIG. 3 with the windshield assembly of FIG. 3 in an open position, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

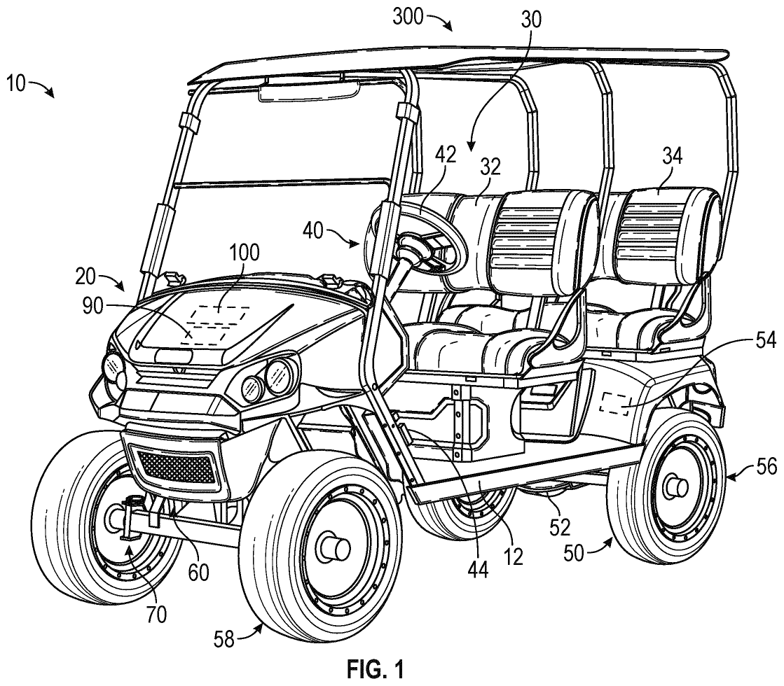

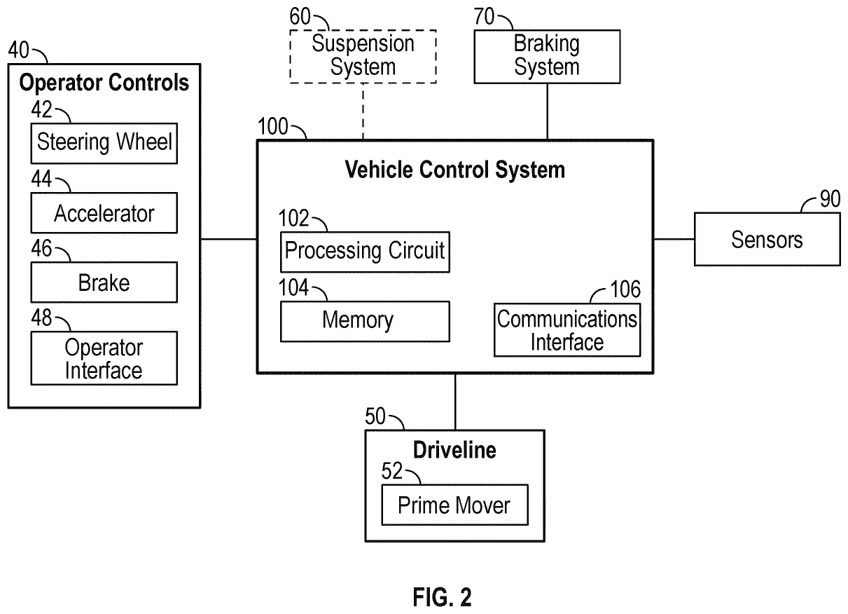

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), a low speed vehicle (“LSV”), a personal transport vehicle (“PTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.).

According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Canopy Assembly

As shown in FIGS. 1, 3, and 4, the vehicle 10 includes a roof assembly, shown as canopy assembly 300. According to an exemplary embodiment, the canopy assembly 300 is supported by the frame 12 of the vehicle (e.g., coupled to the frame 12, etc.). The canopy assembly 300 is positioned above the occupant seating area 30 and is configured to provide shade and protection from inclement weather (e.g., rain, sleet, etc.).

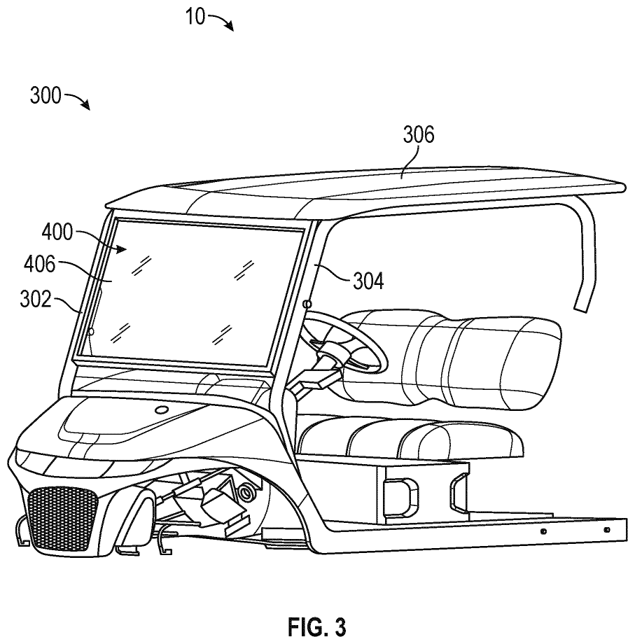

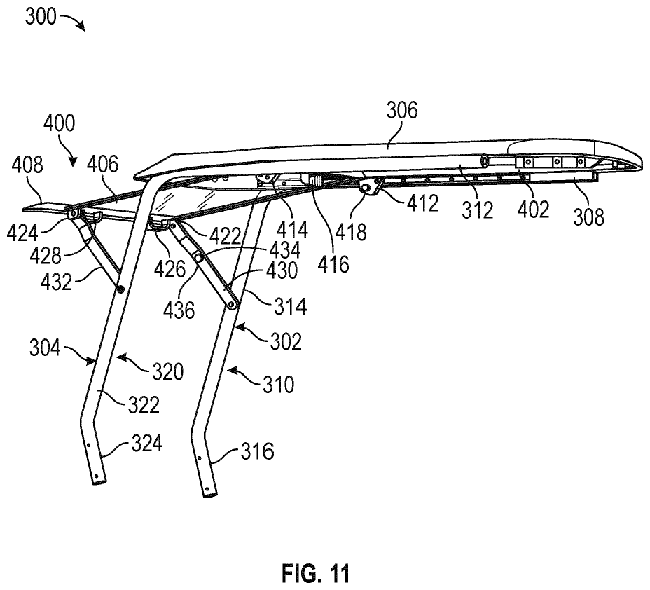

As shown in FIG. 3-5 and 11-13, the canopy assembly 300 includes a first support, shown as first canopy support 302, a second support, shown as second canopy support 304, and a roof, shown as canopy 306. The first canopy support 302 and the second canopy support 304 are configured to couple the canopy 306 to the frame 12 and/or the body 20 of the vehicle 10. In some embodiments, the first canopy support 302 and the second canopy support 304 include or are manufactured from a metallic material (e.g., aluminum). In other embodiments, the first canopy support 302 and the second canopy support 304 is manufactured from another material such as carbon fiber or plastic. According to this embodiment, the canopy 306 is manufactured from a rigid material, such as a plastic or a metallic material.

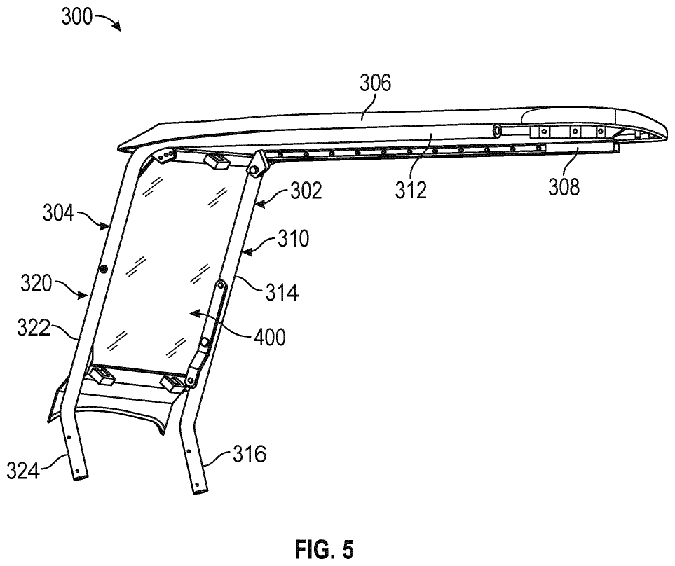

As shown in FIGS. 5 and 10-13, the first canopy support 302 includes a first portion, shown as first canopy support portion 308, and a second portion, shown as first connection support portion 310. In some embodiments, the first canopy support portion 308 is continuous with the first connection support portion 310. For example, the first canopy support 302 may be curved (e.g., bent, manufactured, etc.) to form each of the first canopy support portion 308 and the first connection support portion 310. According to an exemplary embodiment, the first canopy support portion 308 is oriented substantially parallel to the frame 12. As shown in FIGS. 5, 11, and 12, the first connection support portion 310 extends downward from a front end of the first canopy support portion 308 at an angle (e.g., a forward sloping angle such that the upper end thereof is positioned rearward of the lower end thereof). In other embodiments, the first canopy support portion 308 and the first connection support portion 310 are manufactured separately and coupled to each other (e.g., with fasteners, welded, etc.).

As shown in FIGS. 5 and 10-13, the first connection support portion 310 includes a first end, shown as upper end 314, coupled to the first canopy support portion 308 and a second end, shown as lower end 316, coupled (e.g., secured, attached, etc.) to the frame 12. The upper end 314 extends downward from the first canopy support portion 308. According to an exemplary embodiment, the first connection support portion 310 is coupled a peripheral side of the body 20 (e.g., a hood) of the vehicle 10 where the lower end 316 meets the upper end 314 of the first connection support portion 310. According to an exemplary embodiment, the lower end 316 extends away from the upper end 314 at an angle (e.g., at a rearward sloping angle such that the upper end thereof is positioned forward of the lower end thereof).

As shown in FIG. 3-5 and 10-13, the second canopy support 304 is positioned a distance away from the first canopy support 302 on a side of the vehicle 10 opposite the first canopy support 302. The second canopy support 304 is substantially similar to the first canopy support 302. As shown in FIGS. 5 and 10-13, the second canopy support 304 includes a first portion, shown as second canopy support portion 312, and a second portion, shown as second connection support portion 320. In some embodiments, the second canopy support portion 312 is continuous with the second connection support portion 320. For example, the second canopy support 304 may be curved (e.g., bent, manufactured, etc.) to form each of the second canopy support portion 312 and the second connection support portion 320. According to an exemplary embodiment, the second canopy support portion 312 is oriented substantially parallel to the frame 12. As shown in FIGS. 5 and 11-13, the second connection support portion 320 extends downward from the second canopy support portion 312 at an angle (e.g., a forward sloping angle such that the upper end thereof is positioned rearward of the lower end thereof). In other embodiments, the second canopy support portion 312 and the second connection support portion 320 are be manufactured separately and coupled to each other (e.g., with fasteners, welded, etc.).

As shown in FIGS. 5 and 10-13, the second connection support portion 320 includes a first end, shown as upper end 322, and a second end, shown as lower end 324, coupled (e.g., secured, attached, etc.) to the frame 12. The upper end 322 extends downward from the second canopy support portion 312. According to an exemplary embodiment, the second connection support portion 320 is coupled a peripheral side the body 20 of the vehicle 10 where the lower end 324 meets the upper end 322 of the second connection support portion 320. According to an exemplary embodiment, the lower end 324 extends away from the upper end 322 at an angle (e.g., at a rearward sloping angle such that the upper end thereof is positioned forward of the lower end thereof).

### Windshield Assembly

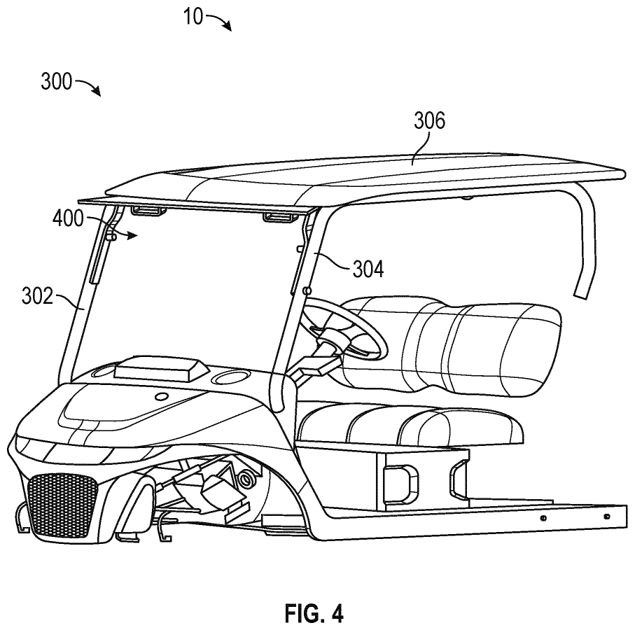

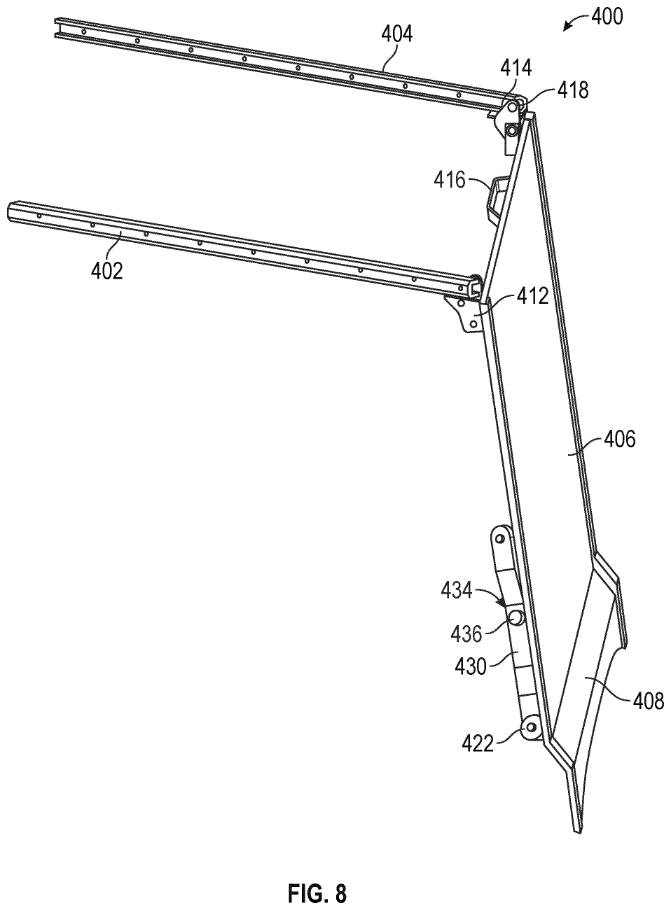

As shown in FIG. 3-13, the canopy assembly 300 includes a window system, shown as windshield assembly 400. As shown in FIGS. 3 and 4, the windshield assembly 400 is positioned at or proximate a front end of the vehicle 10. According to an exemplary embodiment, the windshield assembly 400 is configured to shield and/or prevent wind and debris from flowing into the occupant seating area 30 of the vehicle 10.

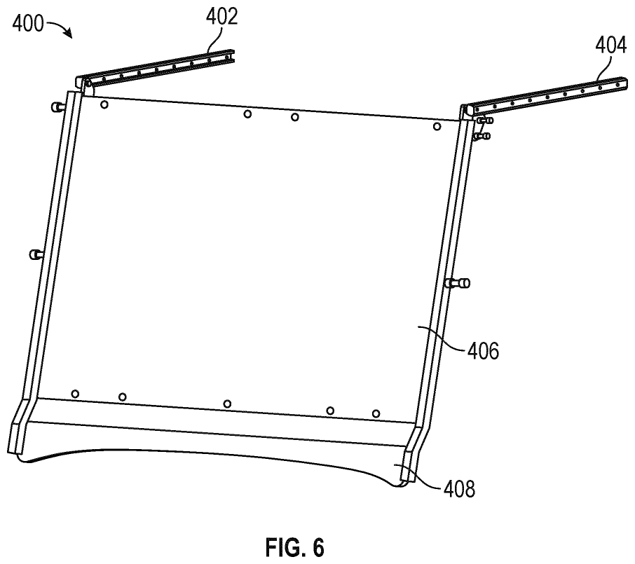

As shown in FIG. 6-8, 11, and 12, the windshield assembly 400 includes a first guide, shown as first track 402. The first track 402 is aligned with, and coupled to, the first canopy support portion 308. The first track 402 is positioned on an inner surface (e.g., a surface opposite a peripheral surface, etc.) of the first canopy support portion 308. By way of example, the first track 402 may be secured to the first canopy support portion 308 with a plurality of fasteners (e.g., screws, rivets, bolts, etc.). According to an exemplary embodiment, the first track 402 extends in a direction substantially parallel to the frame 12.

As shown in FIG. 6-8, the windshield assembly 400 includes a second guide, shown as second track 404. The second track 404 is aligned with, and couple to, the second canopy support portion 312. The second track 404 is positioned on an inner surface of the second canopy support portion 312. By way of example, the second track 404 may be secured to the second canopy support portion 312 with a plurality of fasteners (e.g., screws, rivets, bolts, etc.). According to an exemplary embodiment, the second track 404 extends in a direction substantially parallel to the frame 12.

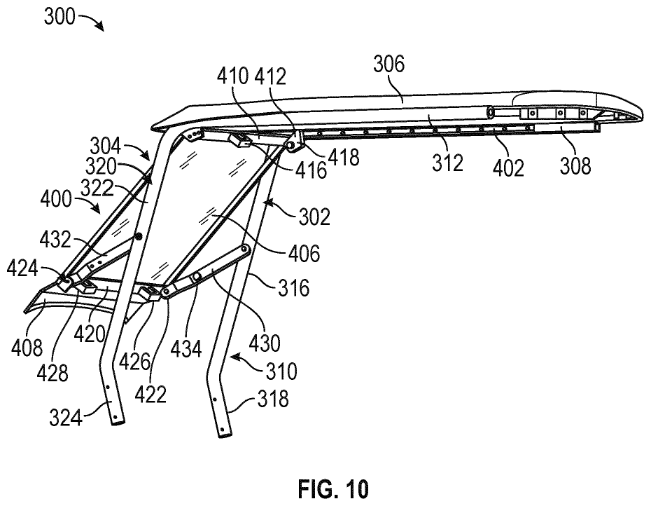

As shown in FIG. 10-12, the first track 402 is positioned on the inner surface of the first canopy support portion 308. Similarly, the second track 404 is positioned on the inner surface of the second canopy support portion 312. Accordingly, the first track 402 and the second track 404 are positioned on surfaces of the first canopy support portion 308 and the second canopy support portion 312, respectively, that are closest to one another. According to an exemplary embodiment, the first track 402 and the second track 404 are positioned on the inner surfaces of each of the first canopy support portion 308 and the second canopy support portion 312, respectively, such that, when looked at a side of the vehicle 10, the first track 402 and the second track 404 are not visible (e.g., they are hidden by the first canopy support portion 308 and the second canopy support portion 312, etc.). According to an exemplary embodiment, the first track 402 and the second track 404 are configured to guide a sliding mechanism (e.g., a wheel, etc.).

As shown in FIG. 6-8 and 10-13, the windshield assembly 400 includes a transparent panel, shown as windshield 406, an extension portion, shown as windshield extension 408, a first windshield support, shown as upper windshield support 410, and a second windshield support, shown as lower windshield support 420. The windshield extension 408 extends from a lower edge of the windshield 406 such that the windshield extension 408 is positioned adjacent to a hood of the body 20 of the vehicle 10 when the windshield 406 is in a closed orientation or configuration. The windshield extension 408 is shaped to compliment the hood of the body 20 of the vehicle 10 such that the windshield extension 408 contacts or engages with the hood of the body 20 of the vehicle 10. The upper windshield support 410 is coupled to and positioned along an upper edge (e.g., an edge nearest the canopy 306, etc.) of the windshield 406. As such, the upper windshield support 410 extends laterally across the upper edge of the windshield 406. The upper windshield support 410 is configured to couple the windshield 406 to the canopy assembly 300 via the first track 402 and the second track 404.

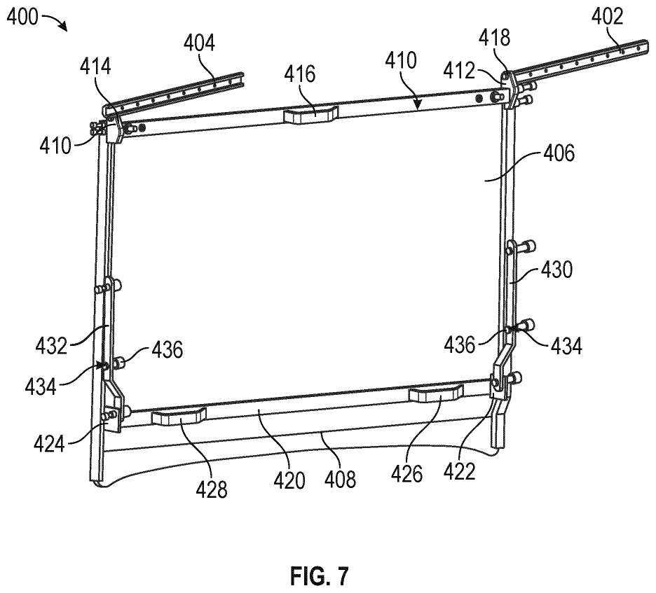

As shown in FIGS. 7, 8, 10-13, the upper windshield support 410 includes a first flange, shown as first bracket 412, and a second flange, shown as second bracket 414. The first bracket 412 is positioned on a first lateral end of the upper windshield support 410 and the second bracket 414 is positioned on a second lateral end of the upper windshield support 410 opposite the first end. The first bracket 412 and the second bracket 414 each extend outward from the upper windshield support 410 towards the occupant seating area 30 (e.g., extend substantially perpendicular to the upper windshield support 410, etc.).

As shown in FIGS. 7, 8, and 10-13, the windshield assembly also includes a translational coupler, shown as sliding mechanism 418, coupled to each of the first bracket 412 and the second bracket 414. For example, the sliding mechanism 418 may include a roller, such as a wheel, that is configured to slide and/or roll within each of the first track 402 and the second track 404.

As shown in FIGS. 7, 8, and 10-12, the upper windshield support 410 includes a first handle, shown as upper handle 416. According to this embodiment, the upper handle 416 is positioned at the center of, and coupled to, the upper windshield support 410. The upper handle 416 is configured to facilitate moving the windshield 406 from a closed position (e.g., as shown in FIG. 3) to an open position (e.g., as shown in FIG. 4) and from the open position back to the closed position. In other embodiments, the upper windshield support 410 includes a different number of handles positioned on, and coupled to, the upper windshield support 410 (e.g., two, zero, etc.).

As shown in FIGS. 7 and 10, the lower windshield support 420 coupled to or positioned proximate a lower edge of the windshield 406 (e.g., an opposing edge to the edge the upper windshield support 410 is positioned along, etc.). The lower windshield support 420 is configured to couple the windshield 406 to each of the first connection support portion 310 and the second connection support portion 320 of the canopy assembly 300.

As shown in FIGS. 7, 10, and 11, the lower windshield support 420 includes a first flange, shown as first bracket 422, and a second flange, shown as second bracket 424. The first bracket 422 is positioned on a first lateral edge of the lower windshield support 420 and the second bracket 424 is positioned on a second lateral edge opposing the first lateral edge of the lower windshield support 420. The first bracket 422 and the second bracket 424 extend inward from the windshield 406 (e.g., substantially perpendicular to the windshield 406, etc.).

As shown in FIGS. 7 and 10-12, the lower windshield support 420 includes a plurality of second handles, shown as first lower handle 426 and second lower handle 428. The first lower handle 426 is coupled to the lower windshield support 420 adjacent to or proximate the first bracket 422. The second lower handle 428 is coupled to the lower windshield support 420 adjacent to or proximate the second bracket 424. Similar to the upper handle 416, the first lower handle 426 and the second lower handle 428 are configured to facilitate moving the windshield 406 from the closed position to the open position and from the open position back to the closed position. In some embodiments, the lower windshield support 420 includes a different number of handles positioned on, and coupled to, the lower windshield support 420 (e.g., one, zero, etc.).

As shown in FIG. 7-13, the windshield assembly 400 includes a plurality of pivotable couplers or links, shown as first link 430 and second link 432. The first link 430 extends between and is pivotably coupled to each of the first bracket 422 and the first connection support portion 310. The second link 432 extends between and is pivotably coupled to each of the second bracket 424 and the second connection support portion 320.

In use and as shown in FIG. 10-13, a user may apply a force to at least one of the first lower handle 426 or the second lower handle 428 by pushing the windshield 406 outward away from the occupant seating area 30, causing the first link 430 and the second link 432 to pivot relative to and extend outward from the first connection support portion 310 and the second connection support portion 320, respectively. As the user continues to apply the force to at least one of the first lower handle 426 or the second lower handle 428, the sliding mechanisms 418 move along the first track 402 and the second track 404 towards a rear end of the vehicle 10, causing the first link 430 to pivot about the first bracket 422 and the first connection support portion 310 and the second link 432 to pivot about the second bracket 424 and the second connection support portion 320.

As shown 7-13, the windshield assembly 400 includes a retainer, shown as locking mechanism 434, coupled to the first link 430. In some embodiments, the locking mechanism 434 is alternatively coupled to the second link 432. In some embodiments, the windshield assembly 400 includes a pair of locking mechanisms 434, a first locking mechanism 434 coupled to the first link 430 and a second locking mechanism 434 coupled to the second link 432. The locking mechanism 434 is configured to secure the windshield 406 in at least one of the closed position or the open position. According to an exemplary embodiment, the locking mechanism 434 includes a pin that engages with one or more apertures defined by the first connection support portion 310 and/or the second connection support portion 320 to secure the windshield 406 is in the closed position and/or the open position. By way of example, the first connection support portion 310 and/or the second connection support portion 320 may define a first, lower aperture and/or a second, upper aperture. When the windshield 406 is in the closed position, the pin of the locking mechanism 434 may engage with the first, lower aperture to secure the windshield 406 in the closed position. Additionally or alternatively, when the windshield 406 is in the open position, the pin of the locking mechanism 434 may engage with the second, upper aperture to secure the windshield 406 in the open position.

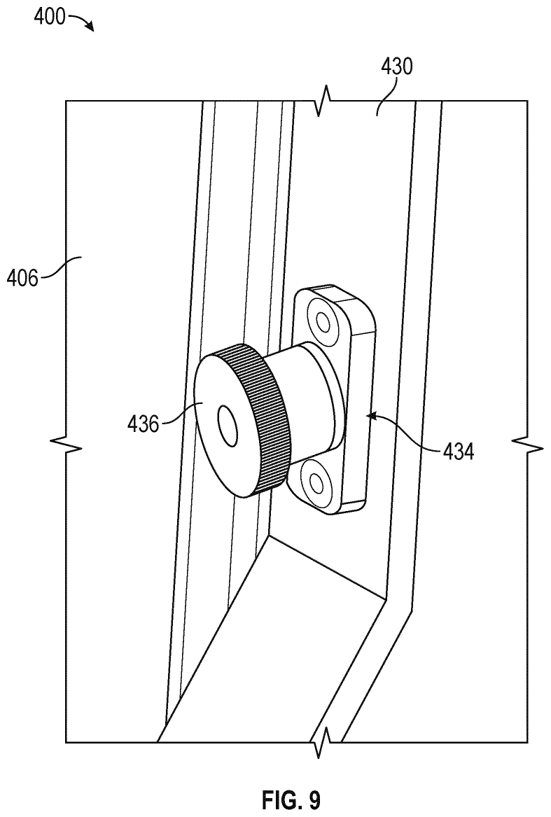

As shown in FIG. 9, the locking mechanism 434 includes a user interface, shown as knob 436. The knob 436 is coupled to the pin and configured to facilitate disengaging the pin from one of the apertures of the first connection support portion 310 or the second connection support portion 320 by pulling on the knob 436 towards a center of the windshield 406. In some embodiments, the pin is spring loaded such that the spring biases the pin into an engaged position with one of the apertures of the first connection support portion 310 or the second connection support portion 320.

In some embodiments, the windshield assembly 400 additionally or alternatively includes one or more of the locking mechanisms 434 positioned on the first bracket 412 and/or the second bracket 414. In such embodiments, the locking mechanisms 434 may be positioned to engage with one or more apertures defined along the first track 402 and/or the second track 404 to secure the windshield 406 in one or more positions including the closed position, the open position, and one or more positions between the closed position and the open position.

According to an exemplary embodiment, the windshield 406 is manufactured from a plastic material. In some embodiments, the windshield 406 is a continuous piece of a plastic that is configured to block wind and debris from flowing into the occupant seating area 30. In other embodiments, the windshield 406 includes a plurality of panels. Each of the panels are pivotably coupled to adjacent panels such that, as the sliding mechanisms 418 glide along the first track 402 and the second track 404, the panels pivot from a position substantially perpendicular to the canopy 306 to a position substantially parallel to the canopy 306 once the panels are adjacent to (e.g., near, etc.) the first track 402 and the second track 404. In other embodiments, the windshield assembly 400 includes a storage support. For example, the storage support may be positioned at a top edge of the windshield 406. When transitioning the windshield assembly from the closed position to the open position, each of the panels are rolled onto the storage support.

In some embodiments, the windshield 406 is manufactured from a flexible and/or bendable material. For example, the windshield 406 can be manufactured from a clear (e.g., transparent, see through, etc.) tarp-like material. The windshield assembly 400 may include a storage support, and the flexible windshield 406 may be rolled onto the storage support to store the windshield 406 in the open position.

In some embodiments, the windshield assembly 400 includes an actuator. In some embodiments, the actuator is a pneumatic cylinder or linear actuator configured to reposition or assist in repositioning the windshield 406 between the closed position and the open position. In some embodiments, the actuator includes a motor. In some embodiments, the windshield assembly 400 includes a button to receive an input from the user to control the actuator to move the windshield assembly 400 from the closed position to the open position and/or from the open position to the closed position. In other embodiments, the actuator is communicably coupled to the vehicle control system 100. For example, the communications interface 106 or the operator controls 40 can receive an input from the user directing the vehicle control system 100 to activate the actuator to move the windshield assembly 400 from the closed position to the open position or from the open position to the closed position.

As shown in FIG. 10-13, the windshield assembly 400 is shown in various positions. As previously described with respect to FIG. 3-6, when in the closed position, the windshield 406 extends substantially parallel to each of first connection support portion 310 and the second connection support portion 320. FIG. 10 illustrates the windshield assembly 400 in a partially open position. As such, the locking mechanism 434 has been disengaged from the first connection support portion 310 and/or the second connection support portion 320. As the user applies a force to at least one of the upper handle 416, the first lower handle 426, and/or the second lower handle 428, the windshield 406 is pushed outward away from the occupant seating area 30.

As shown in FIG. 10-12, when moving the windshield 406 from the closed position to the open position, or a partially open position, the first link 430 and the second link 432 pivot about each of the first connection support portion 310 and the second connection support portion 320, respectively, causing the first link 430 and the second link 432 to rotate outward relative to each of the first connection support portion 310 and the second connection support portion 320. As the windshield 406 is pushed outward away from the occupant seating area 30, the sliding mechanisms 418 slide and/or rotate along the first track 402 and the second track 404 towards the rear end of the vehicle 10. As shown in FIG. 10-12, the windshield 406 pivots outward via the first link 430 and the second link 432 and then slides parallel to the canopy 306 into the open position in which the windshield 406 is secured, via the locking mechanisms 434, in a position substantially parallel to the canopy 306.

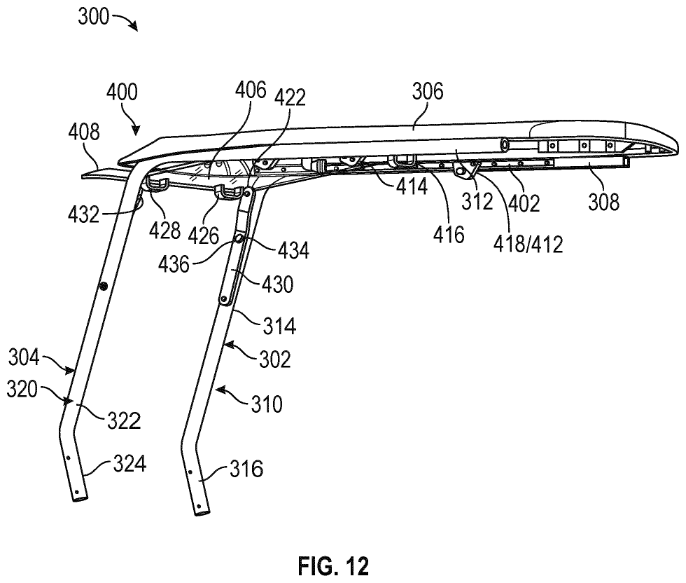

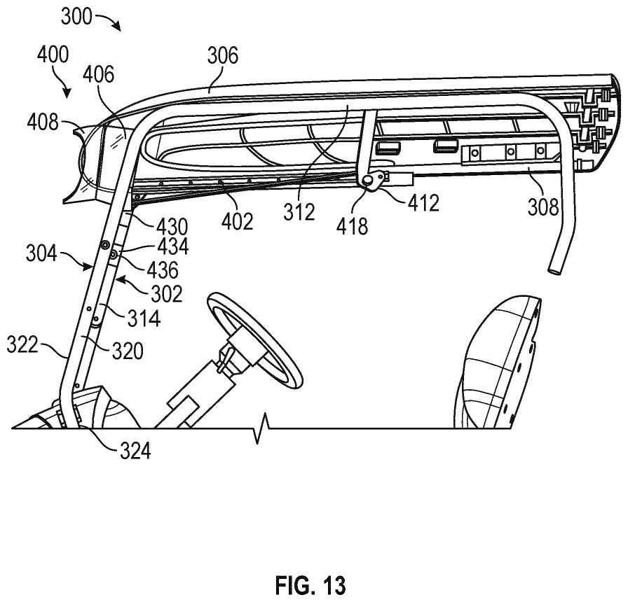

As shown in FIGS. 12 and 13, the canopy 306 defines a canopy cavity at the front end thereof. An underside of the canopy 306 may include apertures and/or brackets for coupling a variety of accessories, such as a speaker, to the canopy 306. The canopy cavity is defined such that the depth has enough clearance for the coupling of accessories to the canopy 306 and securing the windshield 406 in the open position below the accessories coupled to the canopy 306.

The canopy assembly 300 including the windshield assembly 400 allows the user to selectively choose when the windshield 406 is in the open position or in a partially open position. When the windshield 406 is in the partially open position, some air (e.g., less flow than in the open position, etc.) flows into the occupant seating area 30. When the windshield 406 is in the open position, air flows into the occupant seating area 30 cooling the users and/or passengers down. The canopy assembly 300 including the windshield assembly 400 facilitates a more comfortable ride in the vehicle 10 that can be adjusted depending on weather conditions.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A canopy assembly for a vehicle, the canopy assembly comprising:
a first support including a first canopy support portion and a first connection support portion;
a second support including a second canopy support portion and a second connection support portion;
a canopy supported by the first canopy support portion and the second canopy support portion, wherein each of the first canopy support portion and the second canopy support portion is configured to be oriented substantially parallel to a frame of the vehicle, and wherein each of the first connection support portion and the second connection support potion extends downward from the first canopy support portion and the second canopy support portion, respectively; and
a windshield assembly including:
a first track aligned with and coupled to the first canopy support portion;
a second track aligned with and coupled to the second canopy support portion;
a windshield;
a windshield support coupled to the windshield and slidably coupled to the first track and the second track;
a first link pivotably coupled to the windshield and the first connection support portion; and
a second link pivotably coupled to the windshield and the second connection support portion.

2. The canopy assembly of claim 1 wherein the windshield assembly includes a locking mechanism coupled to the first link, the locking mechanism configured to secure the windshield in at least one of a closed position or an open position.

3. The canopy assembly of claim 2, wherein:
the windshield is parallel to f the first connection support and the second connection support when in the closed position; and
the windshield is positioned underneath and substantially parallel to the canopy when in the open position.

4. The canopy assembly of claim 2, wherein the locking mechanism includes a pin that engages with one or more apertures defined by the first connection support portion.

5. The canopy assembly of claim 4, wherein the locking mechanism includes a knob that, when pulled, causes the pin to disengage from the one or more apertures such that the windshield is movable.

6. The vehicle of claim 5, wherein the pin is spring-biased.

7. The canopy assembly of claim 1, wherein the windshield assembly includes a locking mechanism coupled to the first windshield support, the locking mechanism configured to secure the windshield in at least one position.

8. The canopy assembly of claim 7, wherein the locking mechanism includes a pin that engages with one or more apertures defined by the first track.

9. The canopy assembly of claim 1, wherein the windshield assembly includes a handle coupled to the windshield support.

10. The canopy assembly of claim 1, wherein the windshield support is a first windshield support coupled to a first end of the windshield, wherein the windshield assembly includes a second windshield support coupled to an opposing second end of the windshield, wherein the first link and the second link are pivotably coupled to the second windshield support.

11. The canopy assembly of claim 10, wherein the windshield assembly includes a handle coupled to the second windshield support.

12. The canopy assembly of claim 11, wherein the handle is a first handle coupled to the second windshield support adjacent to the first link, and wherein the windshield assembly includes a second handle coupled to the second windshield support adjacent to the second link.

13. The canopy assembly of claim 1, wherein the windshield is flexible or bendable.

14. The canopy assembly of claim 1, wherein the windshield has a plurality of segments.

15. The canopy assembly of claim 14, wherein each segment is pivotably coupled to an adjacent segment.

16. The canopy assembly of claim 14, wherein the plurality of segments can be rolled around a storage support coupled to the first canopy support portion and the second canopy support portion.

17. The canopy assembly of claim 14, wherein at least one segment of the plurality of segments is stationary.

18. The canopy assembly of claim 1, wherein the windshield has an extension portion shaped to complement a body of the vehicle.

19. A windshield assembly for a vehicle, the windshield assembly comprising:
a first track;
a second track;
a windshield;
a windshield support coupled to the windshield and slidably coupled to the first track and the second track;
a first link pivotably coupled to the windshield; and
a second link pivotably coupled to the windshield.

20. A canopy assembly for a vehicle, the canopy assembly comprising:
a first canopy support;
a second canopy support;
a canopy supported by the first canopy support and the second canopy support; and
a windshield assembly including:
a first track coupled to the first support;
a second track coupled to the second support;
a windshield;
a first windshield support coupled to an upper portion of the windshield, the first windshield support slidably coupled to the first track and the second track;
a first handle coupled to the first windshield support;
a second windshield support coupled to a lower portion of the windshield;
a second handle coupled to the second windshield support;
a first link pivotably coupled to the second windshield support and the first canopy support;
a second link pivotably coupled to the second windshield support and the second canopy support; and
a locking mechanism including a pin that engages with one or more apertures defined by at least one of the first canopy support or the first track, the locking mechanism configured to secure the windshield in at least one of a closed position or an open position.
